(19) United States
(12) Patent Application Publication
(10) Pub. No.: US 2022/0210503 A1
(43) Pub. Date: Jun. 30, 2022

(54) METHOD FOR MANAGING THE RECEPTION OF DIGITAL CONTENT BY AN ACCESS DEVICE

(71) Applicant: Orange, Issy-les-Moulineaux (FR)

(72) Inventors: Mathieu Rivoalen, Chatillon Cedex (FR); Hervé Marchand, Chatillon Cedex (FR)

(21) Appl. No.: 17/610,885

(22) PCT Filed: May 11, 2020
(86) PCT No.: PCT/EP2020/062966

§ 371 Date: Nov. 12, 2021

(30) Foreign Application Priority Data
May 13, 2019 (FR) FR1904933

(51) Int. Cl. H04N 21/438; H04N 21/239

(52) U.S. Cl. CPC H04N 21/4384; H04N 21/2393

(57) ABSTRACT

A method for managing access, by an access device, to multimedia content via a communication network. The access device is capable of receiving multimedia content selection commands from a command device and of transmitting a set of access requests corresponding to the content via the communication network. The method includes: detecting a phase of receiving successive selection commands by the access device and for which the interval between consecutive commands is less than a given duration; transmitting, for at least some of the transmitted access requests corresponding to selection commands received during the detected phase, an access request including data relating to the detected phase; and receiving content other than the requested content, the other content including information relating to the demanded content.

### TECHNICAL FIELD

The invention relates to the field of telecommunications.

More particularly, the invention relates to a method for managing access to multimedia contents by an access device for them to be rendered on a rendering device.

Multimedia contents are understood to be any audio and/or video content such as television channels, also called audiovisual channels.

The access device targeted is an entirely separate device that can be connected to a rendering device. This access device is, for example, a television connected to a communication network, a digital television decoder, a home gateway, etc.

### STATE OF THE ART

New command modes for controlling audiovisual devices have recently emerged. The browsing means consist generally in using the direction arrows of a remote control, notably using the P+ and P− buttons to browse or “zap”, very simply between the audiovisual channels offered on a graphical interface rendered on the rendering device.

The time taken for zapping by the P+/P− button on a digital television decoder connected to a network, for example of IPTV (Internet Protocol Television) type, is relatively great, of the order of approximately 3 seconds. In fact, to access a stream broadcast in multicast mode, the decoder must be subscribed to this stream, for example through an IGMP (acronym for “Internet Group Management Protocol”). The time it takes to display the stream on the television then depends on many factors such as the size of the groups of pictures GOP in accordance with the MPEG (acronym for “Moving Picture Experts Group”) standard or the size of the buffer memory (also called buffer) present in the decoder.

Some techniques make it possible to considerably reduce this waiting time like the technique called “fast zapping” known to the person skilled in the art. This technique available for terminals that have a very high bandwidth consists in receiving several data streams at the same time; more particularly, the principle consists in automatically accessing (or “being subscribed to”) a selected channel and also to other channels for example adjacent channels, namely the preceding channel and the next channel. The decoder then receives the data streams corresponding to the three channels, and decodes the corresponding data streams. At this stage, the selected channel is rendered and the other data corresponding to the adjacent channels are received and ready to be rendered on request.

So, if the decoder receives a command to change channel, and the channel targeted forms part of the adjacent channels, in this particular case, this televised channel is rendered without needing to send a subscription command over the network. The result thereof is a very rapid change of channel (also called zapping).

This so-called “fast zapping” technique is, however, very network resource intensive, in particular in terms of bandwidth; in addition, a subscription to the channels is of interest only if the user wants to view the channel concerned. Now, the subscription is made on each channel change request without taking account of whether or not there is a desire to view the channel concerned.

The invention improves the situation.

### The Invention

To this end, according to a functional aspect, the subject of the invention is a method for managing access, by an access device, to multimedia contents via a communication network, the access device being able to receive multimedia content selection commands from a control device and transmit respective access requests via the communication network, characterized in that it comprises
a detection of a phase of reception of successive selection commands (SEL(CH2)-SEL(CH4) by the access device and in which the spacing between consecutive commands is less than a given time (Tmax);
for at least some of the transmitted access requests corresponding to selection commands received during the detected phase, a transmission of an access request including a datum relating to the detected phase,
a step of reception of a content other than the requested content, said other content comprising information relating to the requested content.

According to the invention, the content transmitted following the reception of a request to access a content is not the requested content in all cases. If a fast zapping phase is detected, a phase during which the spacing between consecutive commands is less than a given value, the transmitted content is not the requested content but a replacement content comprising information on the requested content and that can be displayed in place of the selected content, for example a cinema poster if the selected content is a film.

It should be noted that the invention is not limited to the case where the access (or subscription) requests relate to a main content and secondary contents such as adjacent channels. The invention applies also to the case where only a subscription is requested to a main content and is received subsequently from the content server. The bandwidth saving is also considerable in this latter case.

According to a first embodiment, said at least one other content also includes informative data relating to contents other than the selected content. This first embodiment allows the access device to receive, in one and the same response message, several contents other than the requested content. These other contents are informative data relating to multimedia contents other than the selected content. This advance loading reduces the number of access requests to be transmitted subsequently to the content server in a fast zapping phase.

According to one possible variant of the first embodiment, the informative data relating to contents other than the selected content target informative data relating to at least one content adjacent to the selected content.

In fact, upon a fast zapping, the selected contents follow one another; the advance loading of informative data on the adjacent content makes it possible to rapidly display the content when the time comes without the transmission of any access request to the services platform.

According to a second embodiment, which will be able to be implemented as an alternative to or together with the first embodiment,

According to a first embodiment, the spacing between consecutive selection commands concerns the spacing between the current selection command and the selection command received subsequently. In this configuration, according to a variant, of this first embodiment, the method comprises, for each selection command received, a step of triggering of a time delay, and a step of transmission of the corresponding access request at the end of the time delay if no selection command is received during this first time delay. In this configuration, the last access request associated with the fast zapping phase is transmitted. In this way, the last content selected in this so-called fast zapping phase is received and rendered.

According to a third embodiment, which will be able to be implemented as an alternative to or together with the preceding embodiments, the spacing between consecutive commands relates to the spacing between the current command and the command previously received. This second embodiment avoids implementing a time delay.

Time delay here is understood to mean an action to suspend the transmission of an access request.

According to a hardware aspect, the subject of the invention is a device for accessing multimedia contents via a communication network, the access device being able to receive multimedia content selection commands from a control device and transmit respective access requests via the communication network, characterized in that it comprises
a module for detecting a phase of reception of successive selection commands by the access device and in which the spacing between consecutive commands is less than a given time;
a transmission module capable of transmitting, for at least some of the transmitted access requests corresponding to selection commands received during the detected phase, an access request including a datum relating to the detected phase,
a reception module capable of receiving a content other than the requested content, said other content comprising information relating to the requested content.

According to a hardware aspect, the subject of the invention is a computer program that can be implemented on an access device as defined above, the program comprising code instructions which, when it is run by a processor, performs the steps of the management method defined above.

According to another hardware aspect, the subject of the invention is a data medium on which is stored at least one series of program code instructions for the execution of a management method as defined above.

According to another functional aspect, the invention relates to a method for managing the provision of multimedia contents by a content server to an access device, via a communication network, the access device being able to receive multimedia content selection commands from a control device and transmit respective access requests via the communication network, characterized in that it comprises
the obtaining of information relating to the detection of a phase of reception of successive selection commands by the access device and in which the spacing between consecutive commands is less than a given time;
for at least some of the access requests received corresponding to selection commands received during the detected phase, a transmission, in place of the requested content, of at least one other content including informative data relating to the selected content.

According to an embodiment of this other functional aspect, the transmission is preceded by the obtaining of a datum included in the received access request, the datum providing information relating to the detection of a phase of reception of successive selection commands by the access device in which the spacing between consecutive commands is less than a given time.

According to another hardware aspect, the invention relates to a content server capable of receiving content access requests and providing the contents in response, characterized in that it comprises
a module for obtaining information relating to the detection of a phase of reception of successive selection commands by the access device in which the spacing between consecutive commands is less than a given time;
a transmission module capable, in response to at least some of the received access requests corresponding to selection commands received during the detected phase, of transmitting, in place of the requested content, at least one other content including informative data relating to the selected content.

According to another hardware aspect, the invention relates to a computer program that can be implemented on a server as defined above, the program comprising code instructions which, when it is run by a processor, performs the steps of the method linked to said other functional aspect described above.

According to another hardware aspect, the subject of the invention is a data medium on which is stored at least one series of program code instructions for the execution of a method linked to said other functional aspect described above.

The medium concerned targeted above can be any entity or device capable of storing the program. For example, the medium can comprise a storage means, such as a ROM, for example a CD ROM or a microelectronic circuit ROM, or even a magnetic storage means, for example a hard disk. Also, the information medium can be a transmissible medium such as an electrical or optical signal, which can be routed via an electrical or optical cable, wirelessly or by other means. The program according to the invention can in particular be downloaded over a network of Internet type. Alternatively, the information medium can be an integrated circuit in which the program is incorporated, the circuit being adapted to execute or be used in the execution of the method concerned.

The invention will be better understood on reading the following description, given by way of example and with reference to the attached drawings in which:

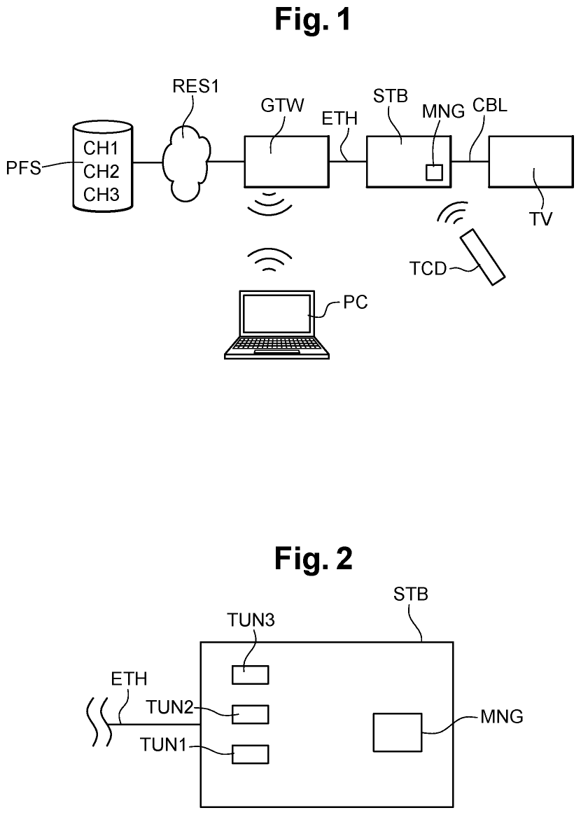

FIG. 1 represents a computing system in which an exemplary embodiment of the invention is illustrated.

FIG. 2 is a schematic view of a decoder according to one embodiment.

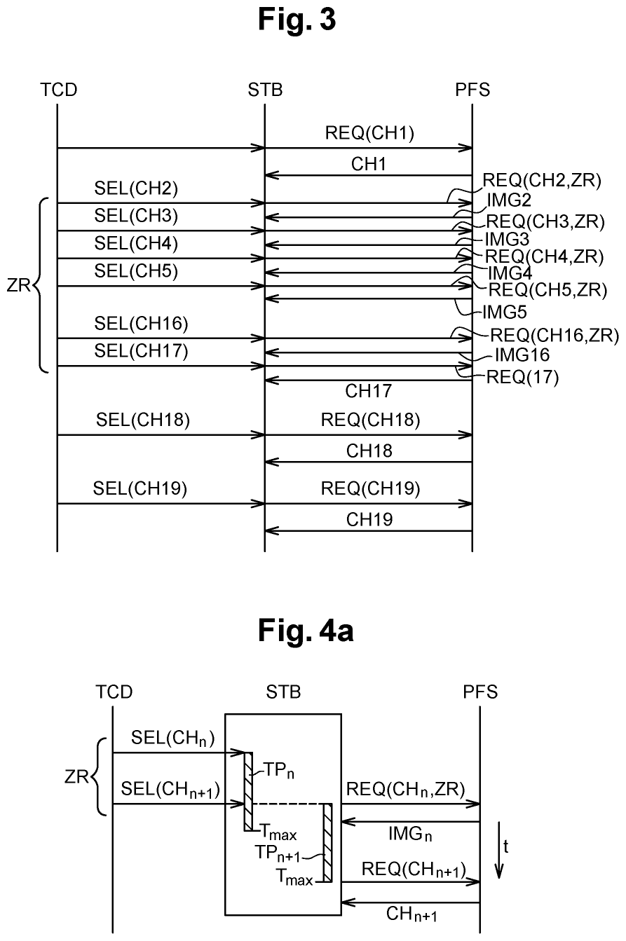

FIG. 3 illustrates an exchange of messages between a remote control, a decoder and a server providing multimedia contents illustrating a first embodiment.

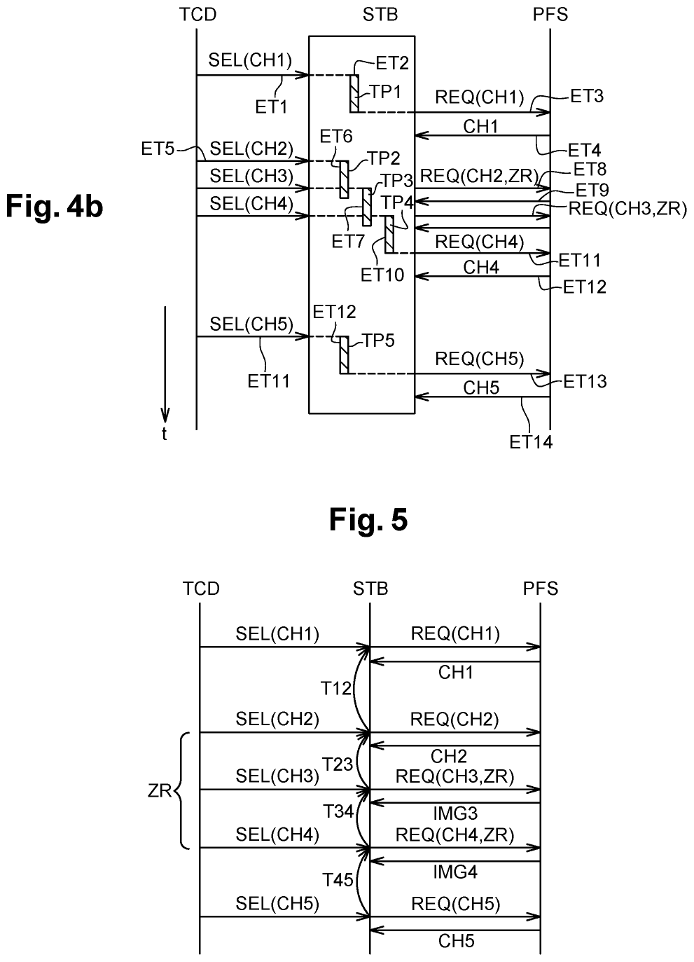

FIG. 4a illustrates a first embodiment for detecting a fast zapping phase using a time delay.

FIG. 4b illustrates an exchange of messages between a remote control, a decoder and a server providing multimedia contents illustrating a second embodiment.

FIG. 5 illustrates an embodiment wherein the transmission of a televised content access request is followed by a reception of informative data relating to several televised contents.

### DETAILED DESCRIPTION OF EMBODIMENTS OF THE INVENTION

FIG. 1 represents a system SYS comprising a control device TCD, an access device STB, a television TV, a services platform PF.

In this example, the device STB is a decoder. This decoder STB communicates with the services platform PFS via a communication network RES1. In this example, this communication takes place via a home gateway GTW (or router). The communication network RES1 used between the gateway GTW and the platform PFS is, for example, a wide area network WAN such as the Internet network.

In this example, the services platform PFS comprises a plurality of services such as access to television channel multimedia contents, video on demand, TV on demand, online games, etc.

In the various examples described in the present text, the contents will be television channels. The platform PFS could also be split up so as to offer services distributed in the network RES1.

In this example, the control device TCD is a remote control TCD which makes it possible to control the decoder STB. A command is for example access to the television channels. Using the remote control, the user can zap from one television channel to another.

The decoder STB and the gateway GTW have a hardware architecture that is equivalent to a computer; the architecture of a computer will not be described in more detail here to simplify the explanation of the invention.

Referring to FIG. 1, the decoder STB comprises an access module capable of requesting the reception (person skilled in the art also uses the expression “capable of subscribing to”) of one or more multimedia data streams illustrated by television channels in this exemplary embodiment. In this example, this access module is a computer program stored in a read-only memory of the decoder STB.

To receive multiple data streams, referring to FIG. 2, in this example, the decoder STB is equipped with several demodulators (also called tuners by the person skilled in the art) TUN1-TUN3. More particularly, this access device DISP is capable of requesting access to a main channel selected via the remote control TCD and requesting reception of other channels CH typically the adjacent channels CH− and CH+, called secondary channels. The request for access to the main channel or to the secondary channels can be made simultaneously or at different instants.

These access requests, also called subscriptions, to the channels concerned, made by the decoder STB, by implication the access module, are in this example the channels CH−/CH/CH+, CH− and CH+ in this example designating the channels adjacent to the rendered channel CH. Channels other than the adjacent channels could have been chosen in addition to or instead of the adjacent channels.

In concrete terms, the decoder STB requests
the reception of a first main stream (which can also be described as “subscribes to the first stream”); that will be rendered on the TV screen,
and, in this example, the reception of secondary streams, namely the adjacent channels CH− and CH+.

After reception of the streams, the decoder STB decodes the three streams received, for example at the same time. At this stage, one television channel is received and rendered, and two other channels are received by the decoder that are ready to be rendered on demand. After reception, the secondary channels are stored in a buffer memory present in the decoder. In this way, if the decoder STB receives a channel change command CH+, the decoder requests the rendering of the channel CH+ instead of the channel CH without requiring the sending of a request to access the requested channel CH+ to the platform PFS. This method speeds up the rendering of a channel.

In this example, the remote control TCD communicates with the decoder STB via a communication link which can be wired (USB, ethernet, etc.) or wireless, for example of WiFi or ZigBee type. In this example, the remote control and the decoder are equipped with respective Zigbee modules.

It will be recalled that Zigbee is a low-power wireless radio technology; it is possible to exchange messages conforming to the Zigbee protocol over a radio channel. It is specified here that the ZigBee protocol is a high-level protocol that allows small radios, with reduced consumption, to communicate based on the IEEE 802.15.4 standard for personal area networks (Wireless Personal Area Networks: WPAN).

In this example, the decoder STB is linked by a cable CBL to the television TV. The cable is, for example, an HDMI cable. In this example, the decoder is linked to the gateway via an ethernet cable ETH.

The decoder STB receives a channel selection command SEL(CHx), for a televised channel CHx (TF1, FR2, BBC, etc.), from the remote control TCD and can transmit an access request REQ(CHx) to the corresponding selected channel CHx.

The user of the remote control TCD can perform several channel jumps. When the channel jumps are fast, the term fast zapping is used. In fast zapping, the transmission of access requests is systematic; that pointlessly clutters the network; in fact, each time a channel is selected, a subscription to the channel is made. Now, when a user fast zaps several channels in succession, for example from a channel CHx to a channel CHy, the subscription to the intermediate channels situated between CHx and CHy is extremely bandwidth intensive; indeed, as explained previously, a subscription or access to a channel leads to the reception of the selected channel but also, in some cases, of the adjacent channels as explained above.

To this end, the invention proposes, when a fast zapping ZR phase is detected, for at least some of the access requests received corresponding to selection commands received during the detected phase, a transmission by the platform, in place of the requested content, of at least one other content including informative data relating to the selected content, this other content being able to be displayed during the fast zapping phase so that the user can see a content corresponding to each selected televised content.

The fast zapping detection phase takes place when selection commands are received in succession and the spacing between consecutive commands is less than a given time (Tmax); more specifically, the spacing between one command received and the next. A sensor (chronometer or other similar devices) measures the time interval between a received command and, if the next command is received before a time Tmax, it is considered that a fast zapping is in progress. If no command is received within this delay Tmax, it is considered that the zapping is normal.

FIG. 3 illustrates the general principle described above. In this FIG. 3, three axes are represented, a first axis for the remote control TCD, a second axis for the decoder STB, and a third axis for the platform PFS.

Selection commands SEL(CHn) are transmitted by the remote control TCD to the decoder STB; the decoder STB then transmits all or some of the requests to access the respective channels CHn to the platform PFS.

In FIG. 3, a first command SEL(CH1) is transmitted to the decoder STB which then transmits a request to access the channel CH1. The decoder STB receives in return a televised stream CH1 which it renders on the screen ECR.

Later, the user fast zaps from the second channel CH2 to the channel CH17.

A management entity MNG, in this example present in the decoder STB, detects this fast zapping ZR phase. Two fast zapping phase determination methods will be explained in detail with reference to FIGS. 4a/4b and 5.

During this fast zapping ZR phase, following the reception of selection commands, the decoder STB of the access requests associated with the selection commands including a datum ZR informing that a fast zapping phase is in progress.

On reception of a request transmitted during a fast zapping ZR, the platform receives the request, extracts the datum ZR and concludes that a fast zapping ZR phase is in progress. In return, the platform PFS transmits, not the requested televised content, but another content relating to the requested televised content, for example a picture. The picture can contain information such as the duration of the televised content, the name of the film if the content is a film, etc.

Following the transmission of the request REQ(CH17), this request not including a datum ZR, the decoder STB receives in return a televised stream CH17 that it renders on the screen ECR.

Following the fast zapping ZR phase, the user views this channel CH17.

Later, the user zaps normally and selects a channel CH18. The decoder STB receives the selection command SEL(CH18) and transmits an access request REQ(CH18) to the platform PFS.

The decoder receives in return a televised stream CH18 that it renders on the screen ECR.

Even later, the user zaps normally and selects a channel CH19. The decoder STB receives the selection command SEL(CH19). No zapping phase is detected, so the decoder STB transmits an access request REQ(CH19) to the platform PFS.

The decoder receives in return a televised stream CH19 that it renders on the screen ECR.

FIGS. 4a and 4b illustrate a solution that makes it possible to detect the fast zapping phase by means of a time counter and of a time delay capable of delaying the transmission of an access request linked to a received access command.

FIG. 4a illustrates the principle used and FIG. 4b illustrates an associated embodiment.

As in FIG. 3, in FIG. 4a, three axes are assigned respectively to the platform PF which transmits televised streams on demand, to the decoder STB and to the remote control TCD.

A first selection command for a televised content CHn (n is an integer number) is received initially. A time delay TPn is implemented.

If no selection command is received during the time delay TPn (case not represented in FIG. 4a), a request to access the selected content is transmitted to the platform PFS.

If a selection command SEL(CHn+1) is received during the time delay TPn, a fast zapping ZR phase is detected. An access request REQ(Cn,ZR) is transmitted and a new time delay TPn+1 is implemented; the request REQ(Cn,ZR) includes a datum ZR informing that a fast zapping phase is detected on the access device.

If no selection command is received during the new time delay TPn+1, that means that the fast zapping phase is finished; a corresponding access request REQ(CHn+1) is transmitted to the platform PFS. This request does not include the datum ZR.

The duration of the time delay is, for example, of the order of 500 ms. In FIGS. 4a and 4b, the maximum time delay time Tmax is represented by shading lines.

According to one possible variant, a datum can also be transmitted without the detection of fast zapping. This datum is included in the access request so as to inform the service platform that there is no fast zapping in progress.

If the user fast zaps just after the television is powered up, that can cause nothing to be displayed on the screen.

In this example, the principle described with reference to FIG. 4a may not be used upon the reception of a first selection command so as to display a content on the screen.

FIG. 4b is a schematic view of successive subscriptions to different channels CHn (“n” is an integer number). It will be seen in this example that the user will select five television channels CH1-CH5 in succession, including some during a fast zapping ZR phase, namely from the current channel CH2 to the channel CH4.

As in FIG. 3, in FIG. 4b, three axes are assigned respectively to the platform PF which transmits televised streams on demand, to the decoder STB and to the remote control TCD.

In this example, as soon as a selection command SEL(CHn) is received by the decoder STB, a timer measures the time which elapses and a time delay delays the transmission of the corresponding access request.

Referring to FIG. 4b, the steps ETm (m is an integer number) illustrating an embodiment based on the principle described above are described hereinbelow.

In a first step ET1, a first television channel CH1 is selected by a user by means of the remote control TCD.

In a second step ET2, the decoder STB receives the selection command SEL(CH1). After reception, a time delay TP1, in this example of 500 ms, is started in a second step ET2.

In this example, the decoder STB does not receive a new selection command during the time delay TP1, the access request REQ(CH1) is therefore transmitted to the platform PFS in a third step ET3.

In this example, the request REQ(CH1) also comprises a request to access the adjacent channels, namely CH0 and CH2; as explained above, that makes it possible, subsequently, when the user zaps to the channel CH2, to display the channel CH2 more rapidly since the latter is already being received by a tuner present in the decoder STB.

The decoder STB receives in return, in a fourth step ET4, streams including the televised stream corresponding to the channel CH1, which can at that moment be rendered on the screen ECR.

Next, the user decides to fast zap several times:

In a fifth step ET5, the user zaps a first time from the first channel CH1 to the second channel CH2. A selection command SEL(CH2) is transmitted to the decoder STB.

On reception, the decoder triggers a time delay TP2 in a sixth step ET6.

During the time delay TP2, the decoder receives a new access command SEL(CH3). The time delay TP2 is canceled; a new time delay TP3 associated with the last command received SEL(CH3) is triggered in a seventh step ET7.

In this example, when the decoder STB receives the selection command SEL(CH3), in an eighth step ET8, an access request REQ(CH2,ZR) is transmitted to the platform PFS, the access request comprising the televised content and a datum ZR informing that a fast zapping ZR is in progress.

In a ninth step ET9, the platform PFS transmits in response a content other than the requested content CH2. The platform transmits one of the data relating to the requested content CH2. In this example, these data are represented by a picture containing, for example, information on the televised content such as the name of the program, the end time, etc.

During the time delay TP3, the decoder receives a new access command SEL(CH4). The time delay TP3 is canceled; a new time delay TP4 associated with the last command received is triggered in a tenth step ET10.

No selection command is received during the time delay TP4, a corresponding access request REQ(CH4) is transmitted in an eleventh step ET11 after the time delay TP4. Since the fast zapping has ended, the request REQ(CH4) does not include any ZR datum.

In a twelfth step ET12, the decoder receives the corresponding channel CH4.

In this example, ten seconds later, in an eleventh step ET11, the user again zaps to the channel CH5.

A time delay TP5 is implemented in a twelfth step ET12.

No selection command is received during this time delay TP5, the decoder STB then transmits, after expiry of the time delay TP5, the corresponding access request REQ(CH5) in a thirteenth step ET13 and receives in return the corresponding televised content CH5 in a fourteenth step. At this stage, the decoder can render the channel concerned CH5 and render it.

FIG. 5 is a variant whereby a transmission of an access request, for example the access request REQ(CH2), the platform transmits informative data IMG2 concerning the requested televised content CH2 but also concerning informative data IMG3-IMG15 on televised contents other than the requested content. In this way, when a content is selected subsequently, for example the content CH3, the associated informative data IMG3 being stored in the access device STB, the latter can be displayed on the screen without requiring transmission of an access request REQ(CH3) requesting access to the content CH3 to the platform PFS. The bandwidth saving is considerable.

According to a second embodiment illustrated in FIG. 5, the detection of a fast zapping phase can be done in a way other than that illustrated with reference to FIGS. 4a and 4b using a time delay. In this second embodiment, when a selection command is received, a measurement of the elapsed time between the current command received and the preceding command received is determined; if the determined time is less than a given time Tmax, the zapping is considered to be fast.

Referring to FIG. 5, a user selects a channel CH1; this selection SEL(CH1) is received by the decoder; since this selection command is the first received, an access request REQ(CH1) is transmitted by the decoder to the platform.

The user then receives another selection command SEL(CH2). The management unit measures the elapsed time T12 between this selection command SEL(CH2) and the preceding one SEL(CH1). In this example, this time T12 is greater than the time Tmax, so the zapping is not therefore a fast zapping; an access request REQ(CH2) is therefore transmitted by the decoder to the platform.

Next, the user selects a channel CH3. The management unit measures the elapsed time T23 between this selection command SEL(CH3) and the preceding one SEL(CH2). In this example, this time T23 is less than the time Tmax, so the zapping is therefore a fast zapping; an access request REQ(CH3,ZR) comprising a televised content identifier and a datum ZR is transmitted by the decoder to the platform. The platform transmits in return another content IMG3 such as an image, in the same way as in FIG. 4b.

Next, the user selects a channel CH4. The measurement unit measures the elapsed time T34 between this selection command SEL(CH4) and the preceding one SEL(CH3). In this example, this time T34 is less than the time Tmax, so the zapping is therefore still a fast zapping; in this example, an access request REQ(CH4,ZR) comprising a televised content identifier and a datum ZR is transmitted by the decoder to the platform. The platform transmits (a step not represented to simplify the drawing) in return another content such as an image, in the same way as in FIG. 4b.

Next, the user selects a channel CH5. The management unit measures the elapsed time T45 between this selection command SEL(CH5) and the preceding one SEL(CH4). In this example, this time T45 is greater than the time Tmax, so the fast zapping has therefore ceased. The access request REQ(CH5) is therefore transmitted by the decoder to the platform.

It should be noted that the detection of the fast ZR phase can be performed outside of the decoder STB. For example, a fast zapping phase detection module can be installed in the remote control. The information relating to the existence of fast zapping can then be transmitted to the decoder STB.

The simplified structure of the decoder STB is now considered according to an exemplary embodiment of the invention. Such a decoder STB is adapted to implement the method for managing access to televised contents.

It is specified here that the access device STB and the content server PFS have the hardware structure of a conventional computer. They notably comprise comprises physical and/or software resources, namely memories M associated with a processor. The memories can be of ROM (Read-Only Memory) or RAM (Random Access Memory) type or even flash type. They notably allow for the storage of a program in the read-only memory for the implementation of the invention. On initialization, the code instructions of the computer program are for example loaded into a RAM memory before being executed by the processing circuit.

Finally, it is specified here that the term module or the term entity can correspond equally to a software component and to a hardware component or a set of hardware and software components, a software component itself corresponding to one or more computer programs or subroutines or more generally to any element of a program that can implement a function or a set of functions as described for the modules concerned. Likewise, a hardware component corresponds to any element of a hardware assembly capable of implementing a function or a set of functions for the module concerned (integrated circuit, chip card, memory card, etc.).

1. A method comprising:
managing access, by an access device, to multimedia contents via a communication network, the access device being able to receive multimedia content selection commands from a control device and transmit respective access requests via the communication network, wherein the managing comprises:
detecting a phase of receiving successive selection commands by the access device and in which a spacing between consecutive commands is less than a given time;
for at least some transmitted access requests corresponding to the selection commands received during the detected phase, transmitting the access requests including a datum relating to the detected phase; and
receiving a content other than the selected content, said other content comprising information relating to the selected content.

2. The method as claimed in claim 1, wherein said at least one other content also includes informative data relating to contents other than the selected content.

3. The method as claimed in claim 2, wherein the informative data relating to contents other than the selected content target informative data relating to at least one content adjacent to the selected content.

4. The method as claimed in claim 1, wherein the spacing between consecutive selection commands concerns spacing between a current selection command and a selection command received subsequently.

5. The method as claimed in claim 4, further comprising, for each selection command received, triggering a time delay, and transmitting the corresponding access request at the end of the time delay if no selection command is received during this time delay.

6. The management method as claimed in claim 1, wherein the spacing between consecutive selection commands relates to spacing between a current command and a command previously received.

7. An access device for accessing multimedia contents via a communication network, the access device being able to receive multimedia content selection commands from a control device and transmit respective access requests via the communication network, wherein the access device comprises:
a processor; and
a non-transitory computer-readable medium comprising instructions stored thereon which when executed by the processor configure the access device to:
detect a phase of receiving successive selection commands by the access device and in which a spacing between consecutive commands is less than a given time;
transmitting, for at least some transmitted access requests corresponding to the selection commands received during the detected phase, access requests including a datum relating to the detected phase; and
receiving a content other than the selected content, said other content comprising information relating to the selected content.

8. (canceled)

9. A non-transitory computer-readable data medium on which is stored at least one series of program code instructions for executing a method of managing access when the instructions are executed by a processor of an access device, wherein the method comprises:
managing access, by the access device, to multimedia contents via a communication network, the access device being able to receive multimedia content selection commands from a control device and transmit respective access requests via the communication network, wherein the managing comprises:
detecting a phase of receiving successive selection commands by the access device and in which a spacing between consecutive commands is less than a given time;
for at least some transmitted access requests corresponding to the selection commands received during the detected phase, transmitting the access requests including a datum relating to the detected phase; and
receiving a content other than the selected content, said other content comprising information relating to the selected content.

10. A method for managing provision of multimedia contents by a content server to an access device, via a communication network, the access device being able to receive multimedia content selection commands from a control device and transmit respective access requests corresponding to the contents via the communication network, wherein the method comprises:
receiving the access requests;
obtaining information relating to detection of a phase of reception of successive selection commands by the access device and in which a spacing between consecutive selection commands is less than a given time; and
for at least some of the access requests received corresponding to selection commands received by the access device during the detected phase, transmitting, in place of the selected content, at least one other content including informative data relating to the selected content.

11. The method as claimed in claim 10, wherein the transmitting is preceded by obtaining a datum included in at least one of the received access requests, the datum providing the information relating to the detection of the phase of reception of successive selection commands by the access device in which the spacing between the consecutive selection commands is less than the given time.

12. A content server capable of receiving content access requests transmitted by an access device via a communication network and providing the content in response, wherein the access device is able to receive multimedia content selection commands from a control device and transmit respective access requests corresponding to the content via the communication network, and wherein the content server comprises:
a processor; and
a non-transitory computer-readable medium comprising instructions stored thereon which when executed by the processor configure the content server to:
receiving the access requests;
obtain information relating to detection of a phase of reception of successive selection commands by an access device in which spacing between consecutive selection commands is less than a given time; and
in response to at least some of the received access requests corresponding to selection commands received during the detected phase, transmitting, in place of the selected content, at least one other content including informative data relating to the selected content.

13. (canceled)

14. A non-transitory computer-readable data medium on which is stored at least one series of program code instructions for executing a method of managing provision of multimedia contents to an access device via a communication network when the instructions are executed by a processor of a content server, wherein the access device is able to receive multimedia content selection commands from a control device and transmit respective access requests corresponding to the contents via the communication network, and wherein the method comprises:
receiving the access requests;
obtaining information relating to detection of a phase of reception of successive selection commands by the access device and in which a spacing between consecutive selection commands is less than a given time; and
for at least some of the access requests received corresponding to selection commands received by the access device during the detected phase, transmitting, in place of the selected content, at least one other content including informative data relating to the selected content.
